(19) United States
(12) Patent Application Publication
(10) Pub. No.: US 2020/0383176 A1
(43) Pub. Date: Dec. 3, 2020

(54) ELECTRIC RADIATOR TYPE HEATING APPLIANCE HAVING AT LEAST ONE RADIATING HEATER BODY INCORPORATING TWO RESISTIVE BODY SHIELDED ELEMENTS OPERATING UNDER AN ALTERNATING CURRENT AND UNDER A DIRECT CURRENT

(71) Applicant: LANCEY ENERGY STORAGE, Grenoble (FR)

(72) Inventors: Raphaël MEYER, GRENOBLE (FR); Gilles MOREAU, GRENOBLE (FR)

(21) Appl. No.: 16/464,004

(22) PCT Filed: Nov. 23, 2017
(86) PCT No.: PCT/FR2017/053229

§ 371 Date: May 24, 2019

(30) Foreign Application Priority Data
Nov. 25, 2016 (FR) 16 61505

(51) Int. Cl. H05B 3/28

(52) U.S. Cl. CPC H05B 3/28; H05B 2203/035

(57) ABSTRACT

An electric radiator heating device (10) intended to be electrically connected to an electrical power source comprises an enclosure consisting, at least in part, of a metal casing (11), at least one radiant heater (12, 12a, 12b) implanted in the metal casing (11), N at least one first shielded element (15) consisting of a first type of resistive body capable of generating heat when it is supplied with an alternating electric current and at least one second shielded element (16) consisting of a second resistive body capable of generating heat when it is powered by a direct electric current. Said at least one first shielded element (15) and said at least one second shielded element (16) are embedded in the material (17, 17a, 17b) of said at least one radiant heater (12, 12a, 12b).

### CROSS REFERENCE TO RELATED APPLICATIONS

This application is a National Stage of PCT Application No. PCT/FR2017/053229 filed on Nov. 23, 2017, which claims priority to French Patent Application No. 16/61505 filed on Nov. 25, 2016, the contents each of which are incorporated herein by reference thereto.

### BACKGROUND

The present invention concerns an electrical radiator type heating appliance intended to be electrically connected to an electric power supply source, the appliance comprising a case constituted at least partially by a metallic frame and at least one radiating heater body implanted in the metallic frame.

The invention also relates to an electrical installation comprising at least one such heating appliance whose radiating heater body is electrically connected to a voltage source.

A heating appliance of the type described hereinabove operates on the radiation principle and should not be confused with the heating appliances which operate on the convection principle.

In the field of radiating type heating appliances, there is a first category where the radiating heater body radiates directly the flow of calories that it generates to the outside of the case.

There is a second category where the radiating heater body is called primary radiating heater body, because its role is to heat a secondary radiating body facing it. In this organization, it is the secondary radiating body which radiates the calories to the outside of the case. An advantage of this organization is to give preference to high thermal inertia properties for the primary radiating heater body and to give preference to high emissivity properties for the secondary radiating body.

Conventionally, a heating appliance is designed to operate only in association with a predetermined kind of electric power supply source. Generally, a given heating appliance is designed to operate only in association with an alternating electric voltage source.

Yet, the current trend provides that the residential electrical installations rely on a variety of electric power supply sources, typically combining direct voltage sources and alternating voltage sources, in particular to include a local electricity generation. Yet, in this organization, the known heating appliances can then be used only in association with only part of the available current sources, which is extremely constraining and limiting.

Moreover, it is difficult to be able to accept a variety of electric power supply source types while maintaining a constant heating power, which would be a guarantee of comfort.

### BRIEF SUMMARY

The present invention aims at solving all or part of the drawbacks listed hereinabove.

In this context, there is a need to provide an electrical radiator type heating appliance which can operate indifferently by a power supply via a direct current source or by a power supply via an alternating current source, while ensuring a substantially constant heating power.

To this end, there is proposed an electrical radiator type heating appliance intended to be electrically connected to an electric power supply source, comprising a case constituted at least partially by a metallic frame, at least one radiating heater body implanted in the metallic frame, at least one first shielded element constituted by a first resistive body type adapted to generate heat when it is powered by an alternating electric current, at least one second shielded element constituted by a second resistive body type adapted to generate heat when it is powered by a direct electric current, said at least one first shielded element and said at least one second shielded element being embedded in the material of said at least one radiating heater body.

According to a particular embodiment, the heating appliance comprises one single one-piece radiating heater body implanted in the metallic frame and including said at least one first shielded element and said at least one second shielded element.

According to another particular embodiment, the heating appliance comprises two first shielded elements and one single second shielded element disposed between the two first shielded elements across the thickness of the radiating heater body.

Alternatively, the heating appliance comprises two second shielded elements and one single first shielded element disposed between the two second shielded elements across the thickness of the radiating heater body.

According to yet another particular embodiment, the heating appliance comprises a first radiating heater body and a second radiating heater body distinct from the first radiating heater body, said at least one first shielded element being embedded in the material of the first radiating heater body and said at least one second shielded element being embedded in the material of the second radiating heater body.

According to yet another particular embodiment, said at least one radiating heater body constitutes a primary radiating heater body disposed opposite a secondary radiating body arranged so as to deliver a flow of calories exiting the metallic frame.

According to yet another particular embodiment, the secondary radiating body has a surface facing said at least one radiating heater body and at least partially covered by an absorbing film adapted to absorb all or part of the flow of calories generated by said at least one radiating heater body when the first shielded element is powered by an alternating electric current and/or the second shielded element is powered by a direct electric current.

According to yet another particular embodiment, the heating appliance comprises a management unit housed in the metallic frame and controlling the operation of said at least one first shielded element and its alternating electric current power supply and the operation of said at least one second shielded element and its direct electric current power supply according to a predetermined strategy algorithm stored in a memory of the management unit.

There is also proposed an electrical installation comprising at least one such heating appliance whose said at least one first shielded element is electrically connected to a first alternating voltage source so as to be powered by an alternating electric current and/or whose said at least one second shielded element is electrically connected to a second direct voltage source so as to be powered by a direct electric current.

According to a particular embodiment, the first alternating voltage source powers said at least one first shielded element at a first voltage level and the second direct voltage source powers said at least one second shielded element at a second voltage level strictly different from said first voltage level.

According to another particular embodiment, the first voltage level corresponds to the voltage level of the local electrical network, in particular substantially equal to 220V, and the second voltage level is comprised within a range from 20V to 60V, in particular substantially equal to 50V.

### BRIEF DESCRIPTION OF THE DRAWINGS

The invention will be better understood using the following description of particular embodiments of the invention provided as non-limiting examples and represented in the appended drawings, in which:

FIG. 1 is a schematic side view representing the components of an example of a heating appliance according to the invention.

FIG. 2 represents a first embodiment of a radiating heater body which can be used in the appliance of FIG. 1.

FIG. 3 represents a second embodiment of a radiating heater body which can be used in the appliance of FIG. 1.

FIG. 4 represents a third embodiment of a radiating heater body which can be used in the appliance of FIG. 1.

### DETAILED DESCRIPTION

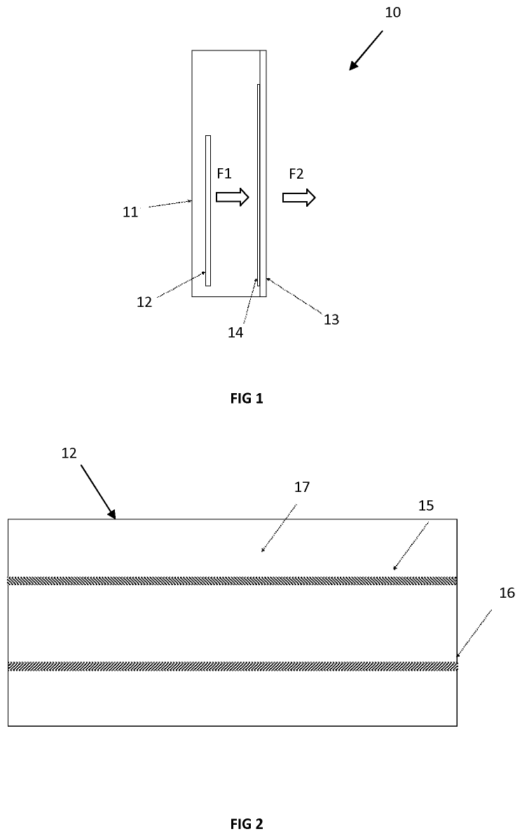

Referring to the appended FIGS. 1 to 4 as summarized hereinabove, the invention essentially concerns an electrical radiator type heating appliance 10 intended to be electrically connected to an electric power supply source. As will be explained later on, the heating appliance 10 is in particular configured so that it can indifferently be electrically connected to a direct voltage supply source and/or electrically connected to an alternating voltage supply source.

The invention also concerns an electrical installation comprising at least one such heating appliance 10 and a direct current type electric power supply source and/or an alternating current type electric power supply source.

The heating appliance 10 comprises a case constituted at least partially by a metallic frame 11 and at least one radiating heater body 12 implanted in the metallic frame 11. It is therefore understood that the heating appliance 10 may comprise one single radiating heater body 12 or a plurality of radiating heater bodies 12a, 12b disposed side-by-side and/or above each other.

The heating appliance 10 also comprises at least one first shielded element 15 constituted by a first resistive body type adapted to generate heat when it is powered by an alternating electric current.

Complementarily to the at least one first shielded element 15, the heating appliance 10 also comprises at least one second shielded element 16 constituted by a second resistive body type adapted to generate when it is powered by a direct electric current.

It is therefore well understood that the number of first shielded elements 15 may be larger than or equal to 1 and each of them delivers heat when it is powered by an alternating electric current source. The number of second shielded elements 16 is also larger than or equal to 1 and, unlike the first shielded element 15, each of them delivers heat when it is powered by a direct electric current source.

The combined presence of at least one first shielded element 15 constituted by a resistive body adapted to generate heat when it is powered by an alternating electric current and at least one second shielded element 16 constituted by a resistive body adapted to generate heat when it is powered by a direct electric current allows ensuring a substantially constant heating power and makes the heating appliance 10 operable under an alternating current source and/or a direct current source. Furthermore, because of the possibility of using simultaneously at least two power supply sources, the heating appliance 10 advantageously features a very high potential temperature rise for its radiating heater body 12.

Now, within the electrical installation, which comprises at least one such heating appliance 10, each first shielded element 15 is electrically connected to a first alternating voltage source so as to be supported by an alternating electric current. Alternatively or in a combined manner, each second shielded element 16 is electrically connected to a second direct voltage source so as to be powered by a direct electric current.

According to a particular embodiment, the first alternating voltage source powers each first shielded element 15 at a first voltage level and the second direct voltage source powers each second shielded element 16 at a second voltage level which is strictly different from the first voltage level. As example, the first voltage level corresponds to the voltage level of the local electrical network, in particular substantially equal to 220V in Europe, and the second voltage level is comprised within a range from 20V to 60V, in particular substantially equal to 50V.

As example, each shielded element 15, 16 constituted by a resistive body comprises a resistive wire placed in a tubular metallic sheath filled with a powdery insulator such as electro-fused magnesia. The rolling of the sheath ensures the compaction of the insulator, necessary to obtain a good thermal conductivity and an excellent mechanical and dielectric strength. The ends of the sheath are sealed, for example by using a resin such as silicone, epoxy or polyurethane, and terminating in a plug, for example made of ceramic.

In general, each first shielded element 15 is embedded in the material 17 of said at least one radiating heater body 12. Similarly, each second shielded element 16 is embedded in the material 17 of said at least one radiating heater body 12. FIGS. 2 to 4 represent three possible embodiments of these general principles.

When at least one first shielded element 15 is powered by an alternating current and/or when at least one second shielded element 16 is powered by a direct current, the radiating heater body 12 emits a flow of calories referenced F1.

In the variant of FIG. 1 which is absolutely not limiting as to the application field targeted by the invention, the radiating heater body 12 is unique and constitutes a radiating heater body called «primary radiating heater body» disposed opposite a secondary radiating body 13 arranged so as to deliver a flow F2 of calories exiting the metallic frame 11. The radiating heater body 12 incorporates at least one first shielded element 15 adapted to operate under an alternating current power supply and at least one second shielded element 16 adapted to operate under a direct current power supply.

The secondary radiating body 13 has a surface facing the radiating heater body 12 and at least partially covered by an absorbing film 14 adapted to absorb all or part of the flow F1 of calories generated by the radiating heater body 12 when the first shielded element 15 is powered by an alternating electric current and/or the second shielded element 16 is powered by a direct electric current.

In this organization, the secondary radiating body 13 is configured so as to give preference to high emissivity properties to the outside of the metallic frame 11. The presence of the secondary radiating body 13 allows lowering the temperature supplied by the first and second shielded elements 15, 16 and stabilizing the temperature of the surface of the appliance 10 in contact with air.

As example, such a secondary radiating body 13 may comprise all or part of the following elements, alone or in combination:
an aluminosilicate, borosilicate or alumino-boro-silicate type tempered glass,
a transparent and temperature-resistant polymer, such as for example polyacrylate,
a sandwich structure including a ceramic with a good emissivity and a good transmission in the far infrared (a wavelength comprised between 2 and 10 μm) range.

The secondary radiating body 13 might advantageously have good transmission properties in the far infrared (a wavelength comprised between 2 and 10 μm) range in order to maximize the amount of radiation emitted by the radiating heater body 12.

Conversely, in the organization of FIG. 1, the material 17 of the radiating heater body 12 in which each first shielded element 15 and each second shielded element 16 are embedded has low thermal inertia properties and a very good thermal conductivity. As example, this material is an aluminum alloy or a copper alloy.

It is recalled that in the organization using the presence of a secondary radiating body 13, it is possible to replace the single and one-piece radiating heater body 12 with at least two distinct and separated radiating heater bodies 12a, 12b, for example by providing that one of these two radiating heater bodies incorporates at least one first shielded element 15 and that the other of these two radiating heater bodies incorporates at least one second shielded element 16.

In a variant which is not represented, it remains even conceivable that the heating appliance 10 does not use a secondary radiating body 13. In this case, the flow F1 of calories generated by said at least one radiating heater body 12, when the first shielded element 15 is powered by an alternating electric current and/or the second shielded element 16 is powered by a direct electric current, is directly transmitted to the outside of the metallic frame 11 through an adapted railing.

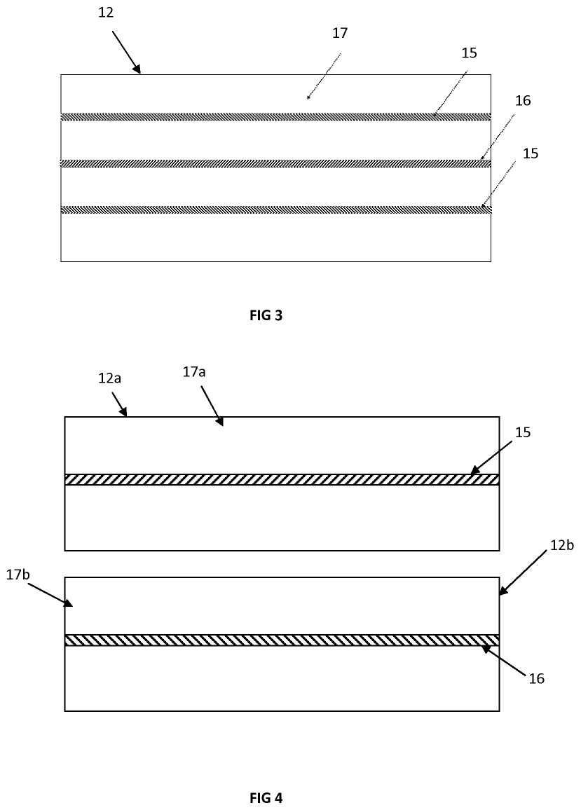

In the versions of FIGS. 2 and 3, the heating appliance 10 comprises one single one-piece radiating heater body 12 implanted in the metallic frame 11 and including said at least one first shielded element 15 and said at least one second shielded element 16, embedded in its material 17.

Conversely, in the version of FIG. 4, the heating appliance 10 comprises a first radiating heater body 12a and a second radiating heater body 12b distinct from the first radiating heater body 12a. Said at least one first shielded element 15 is embedded in the material 17a of the first radiating heater body 12a whereas said at least one second shielded element 16 is embedded in the material 17b of the second radiating heater body 12b. The materials 17a and 17b may be identical or not. The radiating heater bodies 12a and 12b may be disposed side-by-side and/or above each other within the metallic frame 11.

Now, returning to FIG. 3, the heating appliance 10 comprises two first shielded elements 15 and one single second shielded element 16, all embedded in the material 17 of the one and only one-piece radiating heater body 12. The arrangement of the first shielded elements 15 and the second shielded element 16 is such that the second shielded element 16 is disposed between the two first shielded elements 15 across the thickness of the radiating heater body 12.

This organization has the advantage of improving further the potential temperature rise of the radiating heater body 12.

In a non-represented manner, it is possible to provide a variant of FIG. 3 in which the heating appliance 10 comprises two second shielded elements 16 and one single first shielded element 15, all embedded in the material 17 of the one and only one-piece radiating heater body 12. The arrangement of the second shielded elements 16 and the first shielded element 15 is such that the first shielded element 15 is disposed between the two second shielded elements 16 across the thickness of the radiating heater body 12.

Herein again, this arrangement promotes a very rapid temperature rise for the radiating heater body 12.

However, in FIG. 3, the single and one-piece radiating heater body 12 incorporates one single first shielded element 15 and one single shielded element 16.

Moreover, the heating appliance 10 comprises a management unit housed in the metallic frame 11 and controlling the operation of each first shielded element 15 and its alternating electric current power supply and the operation of each second shielded element 16 and its direct electric current power supply, according to a predetermined strategy algorithm stored in a memory of the management unit.

The heating appliance 10 may comprise a temperature sensor adapted to determine the temperature outside the case and elements (wired or not) for transmitting the value determined by the temperature sensor to an input of the management unit. The management algorithm of each first shielded element 15 and of each second shielded element 16 may in particular take into account the value of the temperature outside the case determined by the temperature sensor.

Of course, the invention is not limited to the embodiments that are represented and described hereinabove, but covers, on the contrary, all variants thereof.

1. An electrical radiator type heating appliance intended to be electrically connected to an electric power supply source, comprising a case constituted at least partially by a metallic frame, at least one radiating heater body implanted in the metallic frame, at least one first shielded element constituted by a first resistive body type adapted to generate heat when it is powered by an alternating electric current, at least one second shielded element constituted by a second resistive body type adapted to generate heat when it is powered by a direct electric current, said at least one first shielded element and said at least one second shielded element being embedded in the material of said at least one radiating heater body.

2. The heating appliance according to claim 1, wherein the heating appliance comprises one single one-piece radiating heater body implanted in the metallic frame and including said at least one first shielded element and said at least one second shielded element.

3. The heating appliance according to claim 2, wherein the heating appliance comprises two first shielded elements and one single second shielded element disposed between the two first shielded elements across the thickness of the radiating heater body.

4. The heating appliance according to claim 2, wherein the heating appliance comprises two second shielded elements and one single first shielded element disposed between the two second shielded elements across the thickness of the radiating heater body.

5. The heating appliance according to claim 1, wherein the heating appliance comprises a first radiating heater body and a second radiating heater body distinct from the first radiating heater body, said at least one first shielded element being embedded in the material of the first radiating heater body and said at least one second shielded element being embedded in the material of the second radiating heater body.

6. The heating appliance according to claim 1, wherein said at least one radiating heater body constitutes a primary radiating heater body disposed opposite a secondary radiating body arranged so as to deliver a flow (F2) of calories exiting the metallic frame.

7. The heating appliance according to claim 6, wherein the secondary radiating body has a surface facing said at least one radiating heater body and at least partially covered by an absorbing film adapted to absorb all or part of the flow (F1) of calories generated by said at least one radiating heater body when the first shielded element is powered by an alternating electric current and/or the second shielded element is powered by a direct electric current.

8. The heating appliance according to claim 1, wherein the heating appliance comprises a management unit housed in the metallic frame and controlling the operation of said at least one first shielded element and its alternating electric current power supply and the operation of said at least one second shielded element and its direct electric current power supply according to a predetermined strategy algorithm stored in a memory of the management unit.

9. An electrical installation comprising at least one heating appliance according to claim 1, whose said at least one first shielded element is electrically connected to a first alternating voltage source so as to be powered by an alternating electric current and/or whose said at least one second shielded element is electrically connected to a second direct voltage source so as to be powered by a direct electric current.

10. The electrical installation according to claim 1, wherein the first alternating voltage source powers said at least one first shielded element at a first voltage level and the second direct voltage source powers said at least one second shielded element at a second voltage level strictly different from said first voltage level.

11. The electrical installation according to claim 11, wherein the first voltage level corresponds to the voltage level of the local electrical network, in particular substantially equal to 220V, and in that the second voltage level is comprised within a range from 20V to 60V, in particular substantially equal to 50V.

12. The heating appliance according to claim 2, wherein said at least one radiating heater body constitutes a primary radiating heater body disposed opposite a secondary radiating body arranged so as to deliver a flow (F2) of calories exiting the metallic frame.

13. The heating appliance according to claim 12, wherein the secondary radiating body has a surface facing said at least one radiating heater body and at least partially covered by an absorbing film adapted to absorb all or part of the flow (F1) of calories generated by said at least one radiating heater body when the first shielded element is powered by an alternating electric current and/or the second shielded element is powered by a direct electric current.

14. The heating appliance according to claim 3, wherein said at least one radiating heater body constitutes a primary radiating heater body disposed opposite a secondary radiating body arranged so as to deliver a flow (F2) of calories exiting the metallic frame.

15. The heating appliance according to claim 14, wherein the secondary radiating body has a surface facing said at least one radiating heater body and at least partially covered by an absorbing film adapted to absorb all or part of the flow (F1) of calories generated by said at least one radiating heater body when the first shielded element is powered by an alternating electric current and/or the second shielded element is powered by a direct electric current.

16. The heating appliance according to claim 4, wherein said at least one radiating heater body constitutes a primary radiating heater body disposed opposite a secondary radiating body arranged so as to deliver a flow (F2) of calories exiting the metallic frame.

17. The heating appliance according to claim 16, wherein the secondary radiating body has a surface facing said at least one radiating heater body and at least partially covered by an absorbing film adapted to absorb all or part of the flow (F1) of calories generated by said at least one radiating heater body when the first shielded element is powered by an alternating electric current and/or the second shielded element is powered by a direct electric current.

18. The heating appliance according to claim 2, wherein the heating appliance comprises a management unit housed in the metallic frame and controlling the operation of said at least one first shielded element and its alternating electric current power supply and the operation of said at least one second shielded element and its direct electric current power supply according to a predetermined strategy algorithm stored in a memory of the management unit.

19. The heating appliance according to claim 13, wherein the heating appliance comprises a management unit housed in the metallic frame and controlling the operation of said at least one first shielded element and its alternating electric current power supply and the operation of said at least one second shielded element and its direct electric current power supply according to a predetermined strategy algorithm stored in a memory of the management unit.

20. The heating appliance according to claim 15, wherein the heating appliance comprises a management unit housed in the metallic frame and controlling the operation of said at least one first shielded element and its alternating electric current power supply and the operation of said at least one second shielded element and its direct electric current power supply according to a predetermined strategy algorithm stored in a memory of the management unit.
